(19) United States
(12) Patent Application Publication
(10) Pub. No.: US 2020/0361075 A1
(43) Pub. Date: Nov. 19, 2020

(54) Multi-Tool Turnstile Jig, Workstation and Workbench for Jewelers

(71) Applicant: New Approach Tools, LLC, Arrington, TN (US)

(72) Inventors: Blaine Lewis, Arrington, TN (US); Jason Joseph Marchiafava, Arrington, TN (US)

(21) Appl. No.: 15/931,893

(22) Filed: May 14, 2020

Related U.S. Application Data
(60) Provisional application No. 62/847,664, filed on May 14, 2019.

(51) Int. Cl. B25H 1/10

(52) U.S. Cl. CPC B25H 1/10

(57) ABSTRACT

A turnstile jig for a jeweler's workbench includes a flange for attaching the jig to a support structure, a tower extending directly or indirectly from the flange with multiple tool attachment surfaces, and a turnstile clamp. A manually operated handle operates the turnstile clamp to allow each attachment surface to be selectively rotated to and secured at the front position where the jewel remains positioned. Multiple jeweler's tools may be removably attached to the turnstile jig to create a turnstile workstation, which may be placed upon or affixed to a workbench to create a multi-tool turnstile workbench. The workbench includes a cabinet with a pegboard door that stages tool bits, supplies and accessories for easy access and use with the tools attached to the turnstile jig. Example tools selectively attached to the turnstile jig include a bench pin, a soldering board, a ring clamp and a vice.

### TECHNICAL FIELD

The present invention related to jeweler's benches and, more particularly, to a jeweler's multi-tool turnstile jig, workstation and workbench with a rotating tower that removably supports multiple special-purpose jeweler's tools to provide easy access to a wide range of jeweler's tools.

### BACKGROUND

The traditional jeweler's bench has not changed much over the years. It provides a flat top on which the jeweler can place a variety specialized workstations, such as a bench pin, a ring clamp, a soldering board, an engraving station, a gemstone setting station, and so forth. Changing between workstations is cumbersome and time consuming. While the traditional jeweler's bench has drawers that can hold various bits and hand tools, the drawers do not position the bits and hand tools where then can be easily identified and accessed while working on a piece of jewelry. As a result, the jeweler spends a large portion of their time at the bench switching between workstations and searching for desired bits and hand tools.

Adapters have been developed for different types of workstations commonly placed on the traditional jeweler's bench that pertain to specific tasks and generally center around the adaptation of incorrectly sized worksurfaces to fit different human body sizes. The shortcomings of these adapters is that they only pertain to specific techniques or functions per adapter. Setup and breakdown of multiple adapters is inefficient, while use of each adapter is limited to the specific task traditionally performed on a traditional wooden workstation. Traditional adapters are generally not specifically designed to work with modern equipment and techniques or to fit a broad range of human body types. The drawbacks of the conventional jeweler's workbench include inadequate storage for multiple fixtures, high cost, and having to manually adapt the workbench to facilitate specialized tasks for which they are not properly engineered. A need therefore exists for a more versatile, convenient and effective jeweler's workbench.

### SUMMARY

The needs described above are met by a multi-tool jeweler's turnstile jig, workstation and workbench that includes a flange for attaching the turnstile jig to a support structure, a tower extending directly or indirectly from the flange with multiple tool attachment surfaces, and a turnstile clamp for selectively preventing and allowing rotation of the tower relative to the flange. A manually operated turnstile clamp handle operates the turnstile clamp to allow each attachment surface to be selectively rotated to and secured at the front position where the jeweler remains positioned. Multiple jeweler's tools may be removably attached to the turnstile jig to create a turnstile workstation, which may be placed upon or affixed to a workbench to create a multi-tool turnstile workbench. The workbench includes a cabinet with a pegboard door that stages tool bits, supplies and accessories for easy access and use with the tools attached to the turnstile jig. Example tools that may be selectively attached to the turnstile jig include a bench pin, a soldering board, a ring clamp, and a vice.

It will be understood that specific embodiments may include a variety of features in different combinations, as desired by different users. The specific techniques and systems for implementing particular embodiments of the invention and accomplishing the associated advantages will become apparent from the following detailed description of the embodiments and the appended drawings and claims.

### BRIEF DESCRIPTION OF THE FIGURES

The numerous advantages of the embodiments of the invention may be better understood with reference to the accompanying figures.

FIG. 1A is front perspective view of a turnstile jig for a jeweler's turnstile workstation.

FIG. 1B is a front perspective view of the turnstile jig supporting multiple tool mounting plates.

FIG. 1C is a front perspective view of a turnstile workstation including multiple jeweler's tools supported by the turnstile jig.

FIG. 2A is a top perspective view of the turnstile workstation with a first jeweler's tool in a front position.

FIG. 2B is a top perspective view of the turnstile workstation with a second jeweler's tool in the front position.

FIG. 3A is a front perspective view of the turnstile workstation with the first jeweler's tool in a front position.

FIG. 3B is a front perspective view of the turnstile workstation with the second jeweler's tool in a front position.

FIG. 3C is a front perspective view of the turnstile workstation with a third jeweler's tool in a front position.

FIG. 3D is a front perspective view of the turnstile workstation with a fourth jeweler's tool in a front position.

FIG. 4A is an assembly view of the turnstile jig.

FIG. 4B is an exploded assembly view of the turnstile jig.

FIG. 5 is a perspective view of a workbench for use with the turnstile workstation.

FIG. 6 is a first perspective view of a multi-tool turnstile workbench.

FIG. 7 is a second perspective view of the multi-tool turnstile workbench.

FIG. 8 is a third perspective view of the multi-tool turnstile workbench.

FIG. 9 is a perspective view of the multi-tool turnstile workbench with its pegboard door open.

FIG. 10 is a perspective view of an alternate multi-tool turnstile workbench.

### DETAILED DESCRIPTION

Embodiments of the invention may be deployed in a multi-tool jeweler's workstation and workbench with a turnstile jig that supports multiple tools and rotates to provides easy access to multiple special-purpose jeweler's tools supported by the turnstile jig. The rotating tower also solves focal distance problems with microscope use at a jeweler's bench by its ability to easily adjust to different tooling heights per task without the need to change microscope or user position. The multi-function jeweler's bench also solves workflow logistics for jewelry manufacturing tasks eliminating the need for multiple single-task workstations. This significantly decreases the manufacturing footprint needed for factory manufacturing by a 3-to-1 ratio increasing both efficiency and proficiency. For the first time, the multi-function jeweler's bench allows the user to change function without the need to move or change the physical workstation(s) allowing both flexibility and agility in engineering manufacturing workflows.

The multi-function jeweler's bench easily adjusts to differing human body types for operator(s). which improves environmental health and safety by increasing ergonomic cognitive function for jewelry manufacturing specific to repetitive motion tasks. This also allows for increased efficiency for multi-shift scheduling for manufacturing functions as more than one operator with differing body types can safely use the same workstation at different times and for multiple tasks and functions.

The multi-function jeweler's bench is an all-in-one workstation designed and engineered to function safely and efficiently for multiple jewelry manufacturing processes with and without the use of microscope applications. The rotating tower accommodates a large range of body types without the need for third-party adapters or the need for multiple task-specific workstations. The tower combines all necessary fixtures and appropriate setups in for multiple jewelry manufacturing trade disciplines, including jeweler applications, gemstone setting applications, and hand engraving applications. Previously, these three trade disciplines required different workbenches with different tools setup for each discipline.

The rotating tower also solves focal distance problems with microscope use at a jeweler's bench through a gooseneck microscope mounted to the workbench with the ability to easily adjust to different tooling heights and positions without the need to change the microscope mounting or human positioning. The multi-function jeweler's bench can also be used for any “small” or “micro” observation, diagnostic, fabrication or assembly application that requires specific tools and user postures. For example, the multi-function jeweler's bench may also be used for watchmaking and repair, dental technician applications, eyeglass frame manufacturing and repair, electronics assembly and testing, model making, toy and action figure manufacturing, micro engine and motor assembly and manufacturing, wax carving for model making, and so forth.

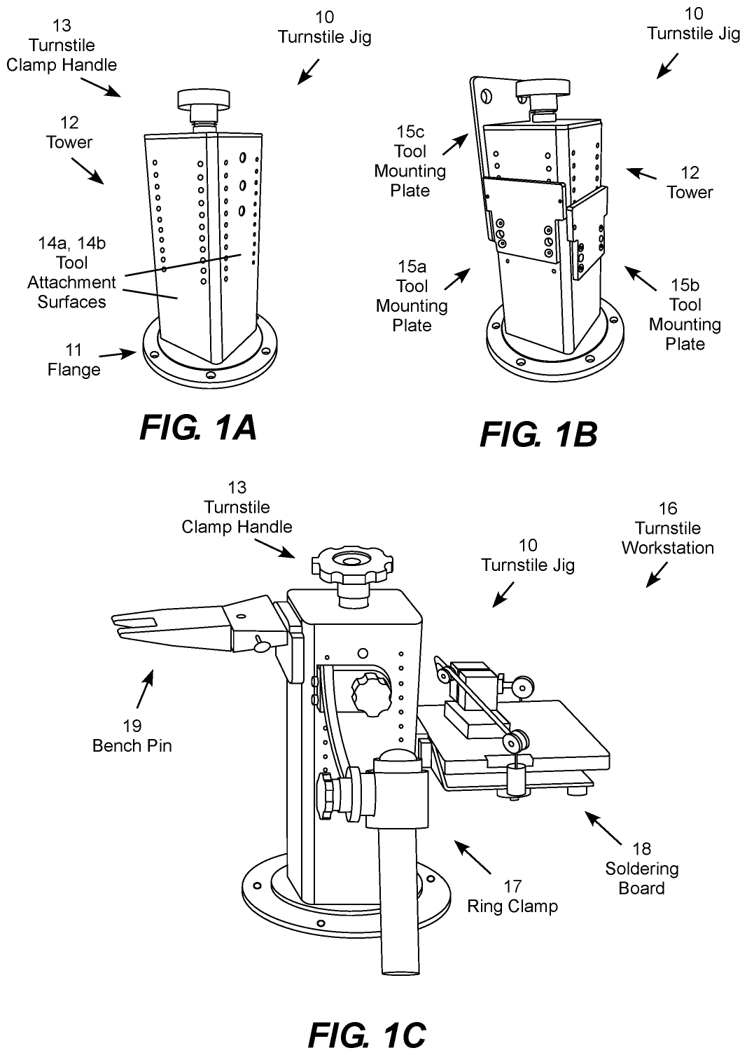

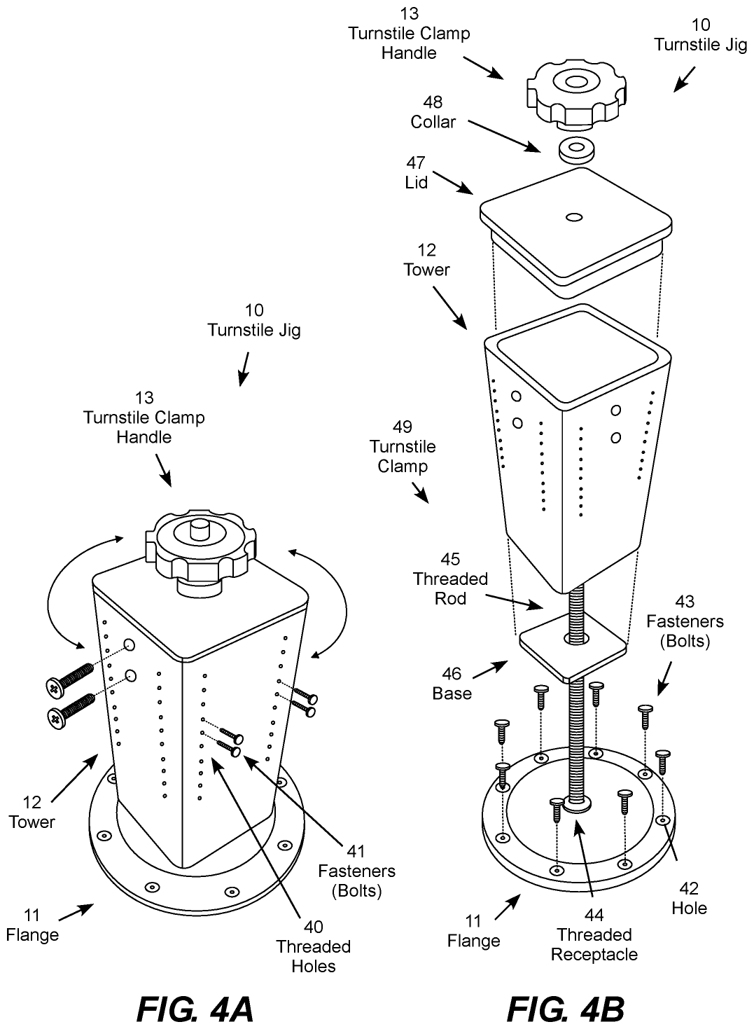

FIG. 1A is front perspective view of a turnstile jig 10 for a jeweler's turnstile workstation. The turnstile jig 10 includes a flange 11 supporting a multi-sided tower 12 with a clamp handle 13 that can be manually turned in one direction (typically clockwise) to tighten a turnstile clamp that selectively secures the tower directly or indirectly to the flange to prevent rotation of the tower with relative to the flange. The turnstile clamp handle 13 can also be manually turned in the other direction (typically counter-clockwise) to release the turnstile clamp to allow the tower 12 to rotate with respect to the flange 11. In this example, the turnstile clamp secures the tower to the flange by tightening the tower directly or indirectly against the flange, and releases the tower by loosening the tower from the flange. The tower 12 is a cylinder with a square cross-section elongated along a central longitudinal axis forming four rectangular tool attachment surfaces extending parallel to the longitudinal axis represented by the tool attachment surfaces 14a and 14b labeled in FIG. 4A. The attachment surfaces may have threaded bolt holes, unthreaded holes, pegs, slots or other features designed to accept specialized tools. In addition, as shown in FIG. 1B, tool mounting plates, represented by the tool mounting plates 15a, 15b and 15c labeled in FIG. 4B, designed to accept specialized tools may be removably attached to the tool attachment surfaces. While each tool mounting plate is attached to an individual tool attachment surface in the illustrated embodiment, a tool mounting plate may be removably attached to multiple tool attachment surfaces if desired.

FIG. 1C is front perspective view of a turnstile workstation 16 that includes the jig 10 supporting various tools removably attached to the tool attachment surfaces directly or by way of respective tool mounting plates. In this particular example, a ring clamp 17, a soldering board 18, and a bench pin 19 are removably attached to respective attachment surfaces of the tower 12. The flange 11 is designed to be attached to a baseboard, workbench, rolling cart, or other suitable support surface. The jeweler (more generally, the user) sits or stands at a work position, generally referred to at the front position, loosens the turnstile clamp handle 13, rotates the tower 12 to bring the desired tool to the front position, and tightens the turnstile clamp to secure the desired tool at the front position. This turnstile action allows the jeweler to quickly bring each tool to the front position, as desired, providing easy access to multiple tools. In addition, the specific tools shown in FIG. 1C are merely illustrative of a wide range of different tools may be readily connected to and removed from the tool attachment surfaces, allowing one tool to be swapped out for another on an as-needed basis. Additional tools may include, for example, a vice, an engraving ball with accompanying shelf, a small anvil, a gluing station, a painting station, a mortar and pestle, and so forth. It will therefore be appreciated that the jeweler may have a large number of tools, any four of which can be attached to the turnstile jig 10 at a time. The specific tools selected for attachment to the turnstile jig can be changed from time to time, and job to job, to facilitate the work of the jeweler or other user.

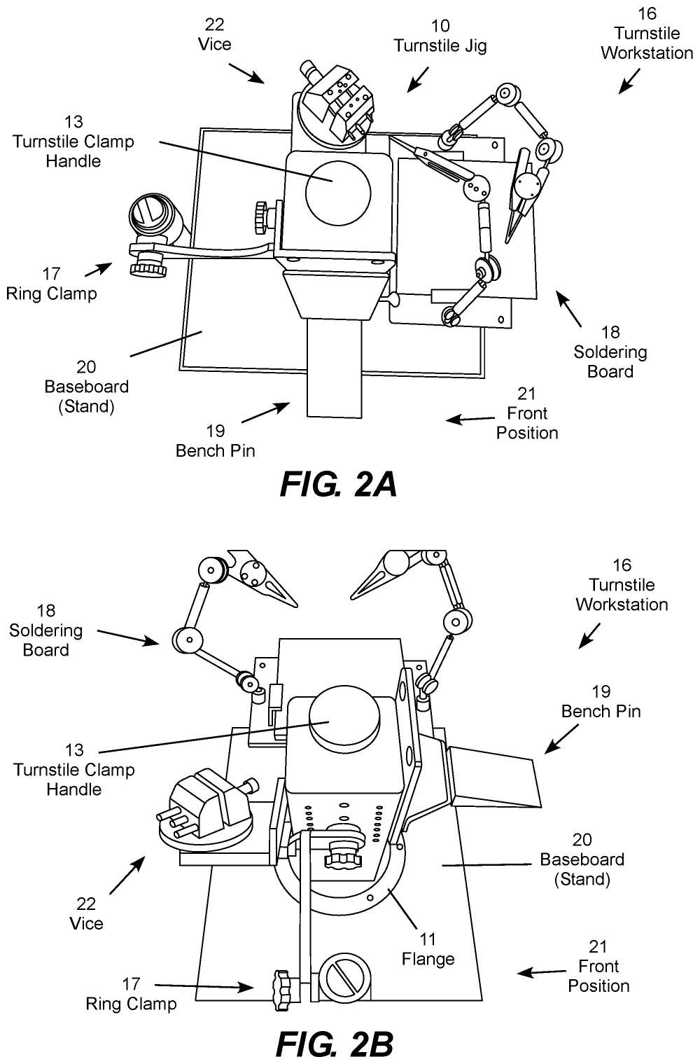

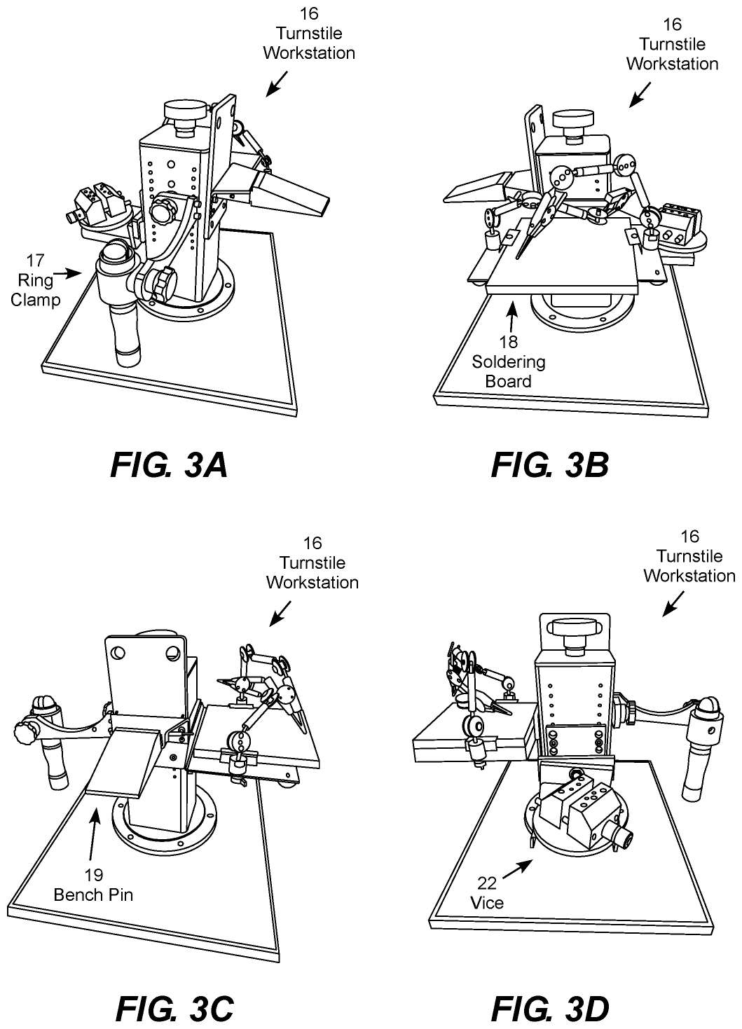

FIG. 2A is a top perspective view of the turnstile workstation 16, which includes a turnstile jig 10 attached to a support surface, in this example a baseboard 20 that serves as a portable stand for the turnstile jig. This is a convenient option allowing the baseboard supporting the turnstile jig to be carried from one place to another and optionally clamped to bolted in place for use at different locations. For descriptive convenience, one side of the baseboard is designated as the front position 21. This example includes four tools attached to the turnstile jig 10, namely a ring clamp 17, a soldering board 18, a bench pin 19, and a vice 22. FIG. 2A shows the turnstile workstation 16 with the bench pin 19 in the front position 21. When desired, the jeweler can turn the turnstile clamp handle 13 to allow the turnstile jig 10 to be rotated with respect to the baseboard 20 to position any of the tools in the front position. As shown in FIG. 2B, for example, the jeweler can rotate the turnstile jig 10 to position the ring clamp 17 in the front position 21. To further illustrate the turnstile functionality, FIG. 3A shows the turnstile workstation 16 with the ring clamp 17 in the front position 21, FIG. 3B shows the turnstile workstation with the soldering board 18 in the front position, FIG. 3C shows the turnstile workstation with the bench pin 19 in the front position, and FIG. 3D shows the turnstile workstation with the vice 22 in the front position.

FIG. 4A is an assembly view and FIG. 4B is an exploded assembly view of the turnstile jig 10. As shown in FIG. 4A, the attachment surfaces of the tower 12 include a variety of threaded holes represented by the labeled hole 40 that accept fasteners represented by the labeled bolt 41 to attach tools and tool mounting places to the tower. The pattern of threaded holes and other tool mounting features, such as slots, pins, etc. may vary on different attachment surfaces. In addition, as shown in FIG. 4A, the flange 11 includes a variety of holes represented by the labeled hole 42 that accept fasteners represented by the labeled bolt 43 to attach the turnstile jig 10 to a baseplate or other suitable support surface. The flange 11 also includes a threaded receptacle 44 that accepts a threaded rod 45 that extends through a base 46, through the tower 12, through a lid 47, through a collar 48, and engages with the turnstile clamp handle 13. The threaded rod 45, base 46, lid 47, collar 48, and clamp handle 13 form a turnstile clamp 49 that allows the clamp handle 13 to be turned to selectively tighten and loosen the tower 12 directly or indirectly to the flange 11. The lid 47 is oriented transverse to the longitudinal direction and located on a top end of the tower 12, the base 46 is oriented transverse to the longitudinal direction and located on a bottom end of the tower. The threaded 45 rod engages with the clamp handle 13, extends in the longitudinal direction through the collar, through the lid, through the tower, through the base, and engages with the flange. In this particular example, threaded rod 45 is engaged directly with the flange 11, and the clamp handle 13 screws along the threaded rod toward the flange to indirectly tighten the tower 12 against the flange by tightening the tower assembly including the collar 48, lid 47, tower 12 and base 46 against the flange. In an alternative embodiment, the tower 12 may bear directly against the flange. The turnstile clamp handle may be secured to the threaded rod 45 by a weld, a set screw, a cotter pin, or a hex socket that captures a hex bolt head or end nut on the threaded rod. Other mechanical arrangements may be used to implement a suitable clamp. For example, the flange 11 may be secured to the threaded rod 45 by a weld, a set screw, a cotter pin, or a hex socket that captures a hex bolt head or end nut on the threaded rod. In this case, the turnstile clamp handle 13 the threaded rod 45 would screw onto but not be otherwise secured the threaded rod 45. As another example, the clamp may include a releasable ratchet and pawl device, a worm gear, a spring operated stop, or any other suitable clamp device.

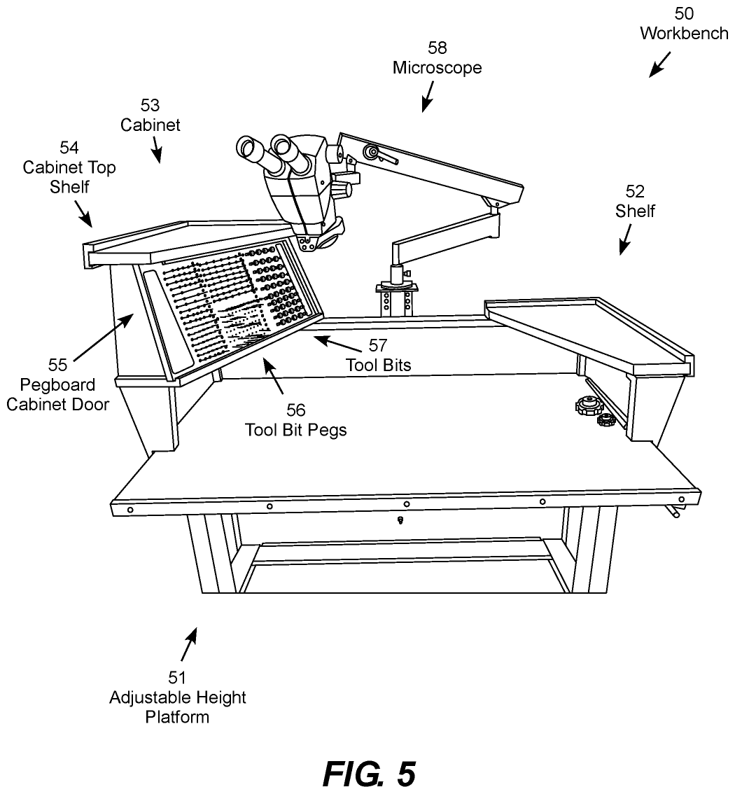

FIG. 5 is a perspective view of a workbench 50 for use with the turnstile workstation 16. The workbench 50 can be built by adding cabinetry to a standard heavy duty work desk including an adjustable height platform 51 that can be raised and lowered, and in certain embodiments may also be tilted forwards and back. The rotating turnstile jig 10, which is typically positioned at or near the center of the table, is configured to receive a number of replaceable tools or other fixtures. The turnstile jig 10 may also be mounted on a slide that allows the tower to be moved toward and away from the front of the platform 51. The work table is typically built on a dolly that allows the workbench to be manually easily moved with the various tools intact. The work table may also include a footrest, which may be adjustable forward and back, and up and down, to suit the user. In this embodiment, the added cabinetry includes a shelf 52 and a cabinet 53 with a top shelf 54 and a pegboard door 55. The shelf 52 and the cabinet 53 are each supported above the platform 51 to provide tabletop space under the shelf and under the cabinet that is easily accessed by the user. The pegboard door includes an array of holes and pegs for staging a selection tool bits 57, supplies and other accessories in convenient reach of the user of the workbench. An optional gooseneck microscope 58 may be attached to the back side of the workbench so that it can be moved along with the bench as an integral unit.

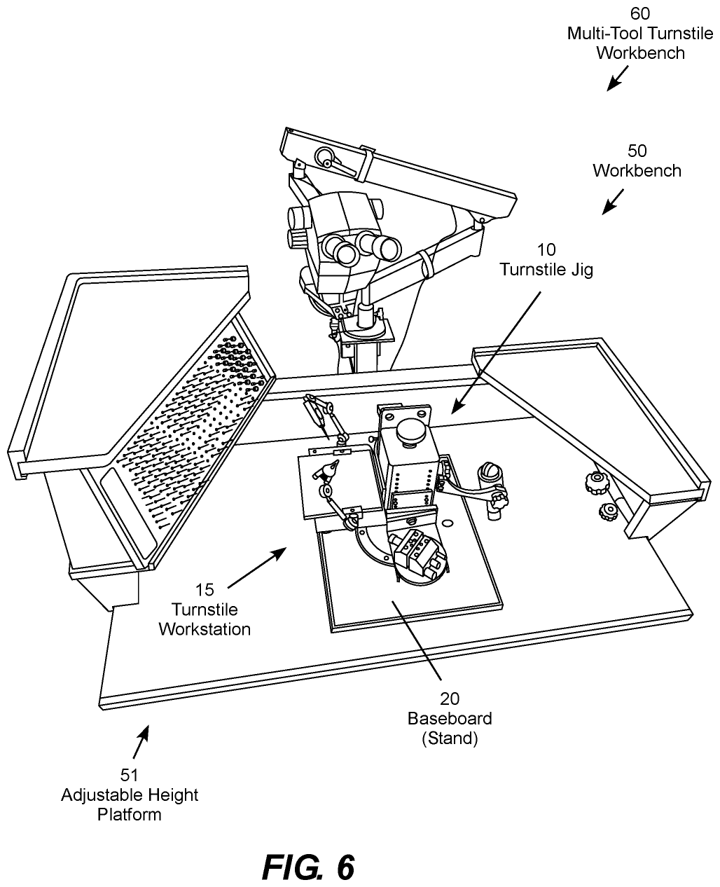

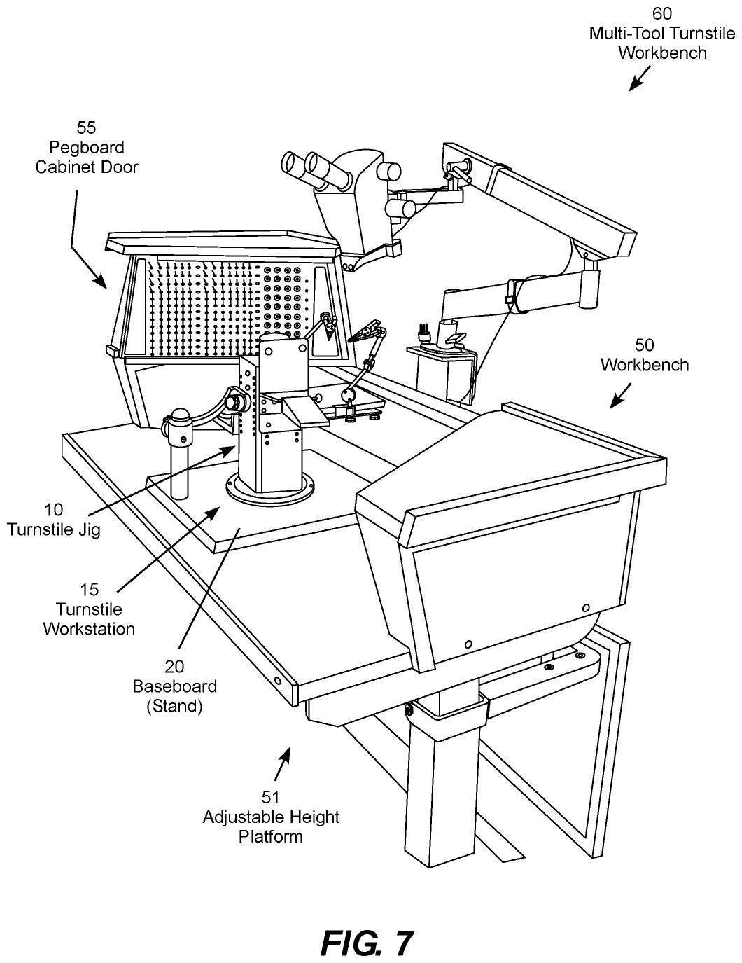

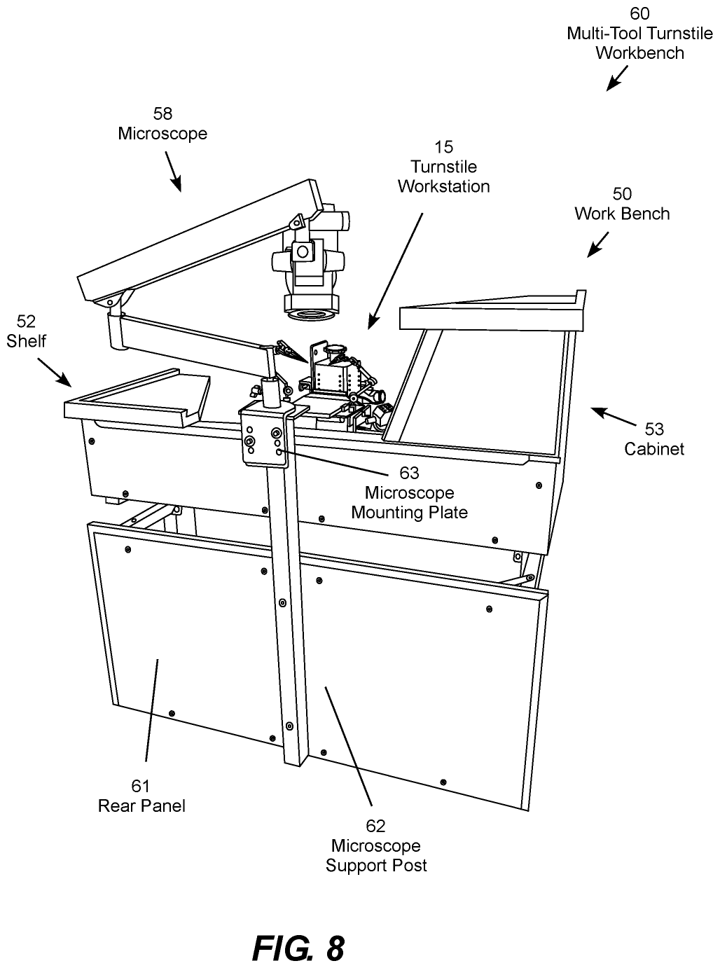

FIGS. 6 and 7 are perspective views of a multi-tool turnstile workbench 60 that includes a turnstile workstation 16 placed on or attached to the adjustable height workbench 50. The flange 11 of the turnstile jig 10 may be attached directly to the adjustable height platform 51 or to a baseboard that is attached to the platform. FIGS. 6 and 7 show an embodiment in which the flange 11 is attached to a baseboard 20 positioned on the platform 51. The baseboard may be screwed, bolted, clamped or otherwise affixed to the platform for added stability. Four tools other fixtures may be attached to the four attachment surfaces of the turnstile jig 10 to equip the workstation for use by the jeweler. FIG. 8 shows the back side of the multi-tool turnstile workbench 60, which includes a rear panel 61 and a microscope support post 62. A microscope mounting plate 63 attached to the post 62 supports the gooseneck microscope 58.

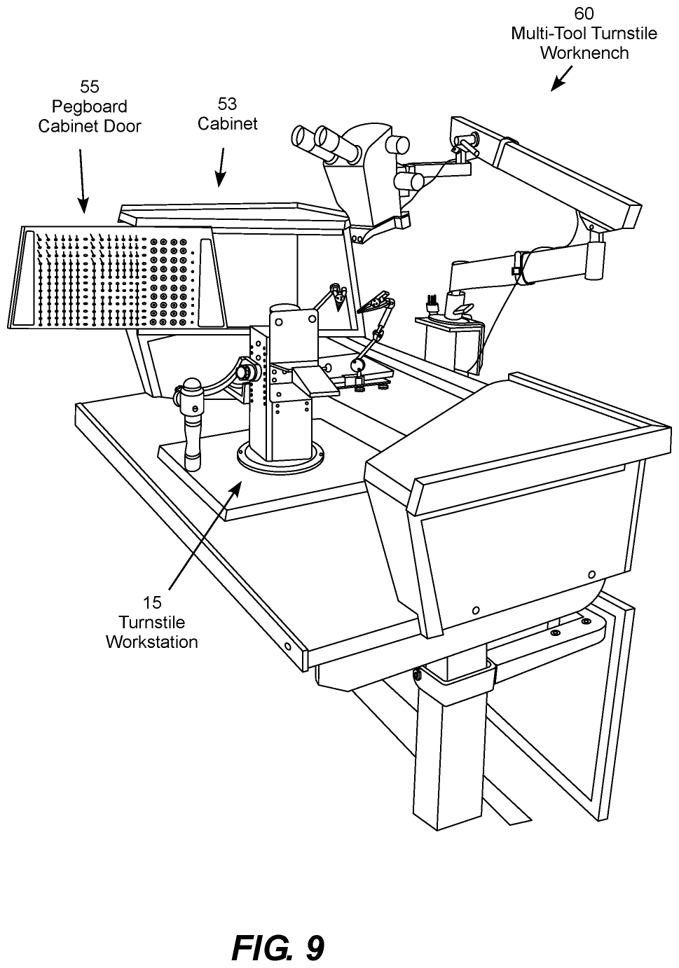

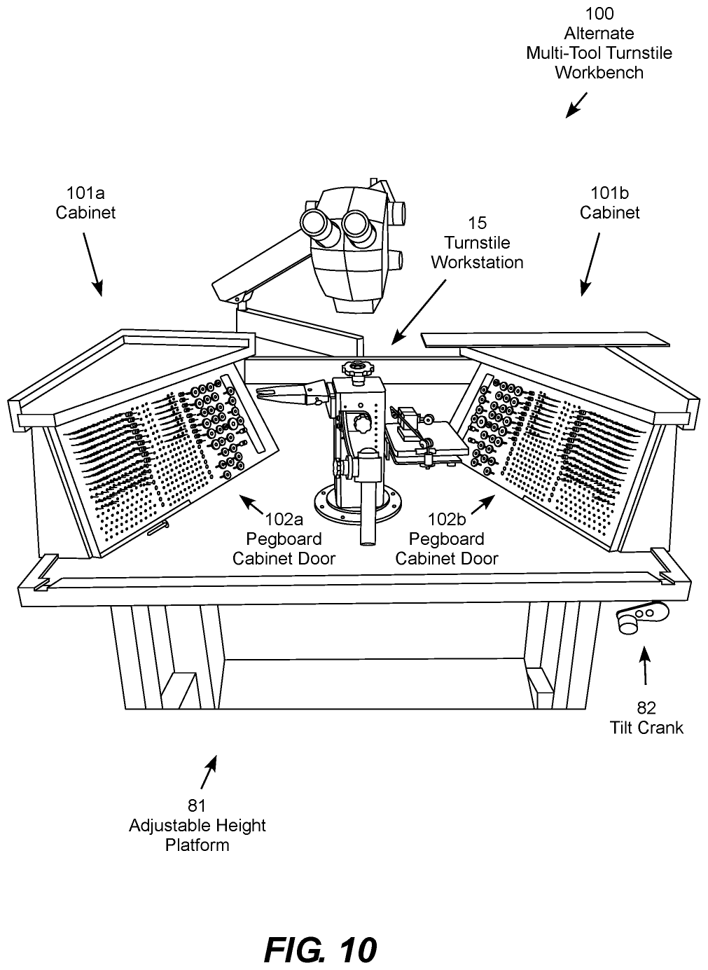

As shown in FIG. 9, the pegboard door 55 slides open to provide convenient access to interior of the cabinet 53. For example, an assortment of tool bits, supplies and accessories may be stored inside the cabinet 53, from which the jeweler selects desired items to be staged on the pegs and holes of the pegboard for ready access. FIG. 10 shows an alternate multi-tool turnstile workbench 100 with different cabinetry. This embodiment includes an adjustable height platform 81 that can be tilted forwards and back through manual operation of a tilt crank 82. This example also includes two cabinets 101a and 101b that each include cabinet doors 102a and 102b, respectively. These particular cabinets extend directly upward from the platform 52 so that there is no tabletop space under the cabinets. It will be appreciated that a range of different cabinetry designs may be employed.

The flange 11, tower 12, handle 13, threaded rod 45, base 46, lid 47 and collar 48 of the turnstile jig 10 are generally fabricated from steel. A lower cost and lighter weight model may be fabricated from high-strength plastic components, such as Acrylonitrile butadiene styrene (ABS), polycarbonate or composite components. Embodiments may also include a mixture steel and plastic components, such as a steel flange 11, threaded rod 45 and collar 48 with the other components fabricated from high-strength plastic. The handle 13 may have a plastic outer body with a threaded steel core. In illustrative embodiment, the turnstile clamp secures the tower to the flange indirectly by tightening the tower assembly including the clamp handle, collar, lid, tower and baseplate against the flange, and releases the tower by loosening the tower assembly from the flange. It will be appreciated that other types of clamps may be used, such as a clamp that uses a ratchet or spring stops to block rotation of the tower relative to the flange rather than tightening the tower against the flange. The cabinetry may be solid wood, plywood, composite panel, plastic or any other suitable material for cabinets. The various tools, such as the ring clamp, bench pin, soldering board, vice and so forth are well known to jewelers. While the representative tower 12 has four tool attachment sides, other shapes may be utilized, such as triangular, pentagonal, hexagonal, and so forth. As an option, one tool attachment side may be larger than the others in a trapezoidal configuration. This would allow a relatively larger tool to be accommodated. Additional fixtures may be attached to the workbench, such as roller stands, reel stands, rulers, packaging equipment, and so forth to further customize the workbench for various applications.

Embodiments of the invention may be sold and deployed as turnstile jig, with or without a supporting backboard, and with or without specific tools, and with or without a workbench. As another option, the turnstile jig may be sold as part of a kit that includes cabinetry panels to be attached to an adjustable height work desk to be acquired separately. Kits including the turnstile jig an special purpose tools selected for specific crafts, with or without craft-specific cabinetry, may also be sold.

While particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The disclosure is defined by the following claims, which should be construed to encompass one or more structures or function of one or more of the illustrative embodiments described above, equivalents and obvious variations. It will therefore be appreciated that the present invention provides significant improvements. The foregoing relates only to the exemplary embodiments of the present invention, and that numerous changes may be made therein without departing from the spirit and scope of the invention as defined by the following claims.

The invention claimed is:

1. A jeweler's turnstile jig, comprising:
a flange for attaching the turnstile jig to a support structure, the flange comprising a front position;
a tower extending in a longitudinal direction from the flange comprising multiple tool attachment surfaces elongated in the longitudinal direction, each for supporting a separate jeweler's tools positioned a respective orientation to the flange;
a turnstile clamp for selectively preventing rotation of the tower relative to the flange, and for selectively allowing rotation of the tower relative to the flange;
a turnstile clamp handle for manually operating the turnstile clamp to allow each attachment surface to be selectively rotated to and secured at the front position.

2. The jeweler's turnstile jig of claim 1, wherein the tower defines a square cross-sectional profile transverse to the longitudinal axis and four rectangular attachment surfaces, each extending parallel to the longitudinal axis.

3. The jeweler's turnstile jig of claim 1, wherein:
the turnstile clamp comprises a threaded rod extending through the tower in the longitudinal direction; and
the turnstile clamp handle selectively preventing rotation of the tower relative to the flange by tightening the tower against the flange.

4. The jeweler's turnstile jig of claim 1, wherein each tool attachment surface comprises one or more threaded holes for attachment of a tool or a tool mounting plate to the attachment surface.

5. The jeweler's turnstile jig of claim 1, further comprising a tool mounting plate attached a selected one of the attachment surfaces for attachment of a tool or a tool mounting plate to the selected attachment surface.

6. The jeweler's turnstile jig of claim 1, wherein each tool attachment surface comprises one or more threaded holes for attachment of a tool or a tool mounting plate to the attachment surface.

7. The jeweler's turnstile jig of claim 1, further comprising a lid oriented transverse to the longitudinal direction located on a top end of the tower, a base oriented transverse to the longitudinal direction located on a bottom end of the tower, and the threaded rod extending in the longitudinal direction extending through the lid, through the tower, through the base, and engaged with the flange and the turnstile clamp handle.

8. A jeweler's turnstile workstation, comprising:
a turnstile jig comprising a flange for attaching the turnstile jig to a support structure, the flange comprising a front position, a tower extending in a longitudinal direction from the flange comprising multiple tool attachment surfaces elongated in the longitudinal direction, each for supporting a separate jeweler's tools positioned a respective orientation to the flange, a turnstile clamp for selectively preventing rotation of the tower relative to the flange, and for selectively allowing rotation of the tower relative to the flange, and a turnstile clamp handle for manually operating the turnstile clamp;
a baseboard supporting the turnstile jig; and
and a plurality of jeweler's tools, each removably attached to a respective one of the attachment surfaces.

9. The jeweler's turnstile workstation of claim 8, wherein the jeweler's tools comprise a bench pin.

10. The jeweler's turnstile workstation of claim 8, wherein the jeweler's tools comprise a soldering board.

11. The jeweler's turnstile workstation of claim 8, wherein the jeweler's tools comprise a ring clamp.

12. The jeweler's turnstile workstation of claim 8, wherein the jeweler's tools comprise a vice.

13. The jeweler's turnstile workstation of claim 8, wherein the jeweler's tools comprise a bench pin, a soldering board, a ring clamp, and a vice.

14. A jeweler's multi-tool turnstile workstation, comprising:
a turnstile jig comprising a flange for attaching the turnstile jig to a support structure, the flange comprising a front position, a tower extending in a longitudinal direction from the flange comprising multiple tool attachment surfaces elongated in the longitudinal direction, each for supporting a separate jeweler's tools positioned a respective orientation to the flange, a turnstile clamp for selectively preventing rotation of the tower relative to the flange, and for selectively allowing rotation of the tower relative to the flange, and a turnstile clamp handle for manually operating the turnstile clamp; and
a workbench supporting the turnstile jig comprising a dolly, an adjustable height platform, and cabinet supported on or above the platform, and a cabinet door comprising a plurality of holes and pins for staging tool bits.

15. The jeweler's turnstile workstation of claim 14, further comprising a gooseneck microscope supported by the workbench.

16. The jeweler's turnstile workstation of claim 14, wherein:
the turnstile clamp comprises a threaded rod extending through the tower in the longitudinal direction; and
the turnstile clamp handle selectively preventing rotation of the tower relative to the flange by tightening the tower directly or indirectly against the flange.

17. The jeweler's turnstile workstation of claim 14, wherein the tower defines a square cross-sectional profile transverse to the longitudinal axis and four rectangular attachment surfaces, each extending parallel to the longitudinal axis.

18. The jeweler's turnstile workstation of claim 14, further comprising a plurality of jeweler's tools, each removably attached to a respective one of the attachment surfaces.

19. The jeweler's turnstile workstation of claim 18, wherein the jeweler's tools comprise one or more of a bench pin, a soldering board, a ring clamp, and a vice.

20. The jeweler's turnstile workstation of claim 19, wherein the jeweler's tools comprise one or more of a bench pin, a soldering board, a ring clamp, and a vice.
